(19) United States
(12) Patent Application Publication
(10) Pub. No.: US 2007/0137407 A1
(43) Pub. Date: Jun. 21, 2007

(54) Twist shift handle bar

(76) Inventor: Arnold B. Kamler, Montville, NJ (US)

Correspondence Address: B2 PATENT SERVICES, 406 ROSEMONT-RINGOES ROAD, STOCKTON, NJ, 08559, US

(21) Appl. No.: 11/265,317

(22) Filed: Nov. 2, 2005

(51) Int. Cl. B62K 21/12; B62K 21/16

(52) U.S. Cl. 74/551.4; 74/551.1

(57) ABSTRACT

This invention relates to a means for attaching a twist shifter to a “Maes Bend” shaped handle bar typically found on road type bicycles. Twist shifters provide the rider better control of bicycle while riding and a more positive shift mechanism. By mounting the shifter in the center section of the handle bars the rider does not need to remove or reposition their hands for shifting and a positive click indicates that a successful shift has been accomplished.

### FIELD OF INVENTION

This invention relates to a novel handle bar assembly for road bicycles capable of being fitted with a twist shifter mechanism. This new handle bar allows the shifter to be placed in the center of the bars for easy access while the rider is in the typical riding position. This makes the shifting process safer as the rider does not have to reposition his hands to shift gears, while offering the more positive shift associated with twist shifting mechanisms.

### BRIEF DESCRIPTION OF THE DRAWINGS

FIG. 1 shows an elevational representation of the two halves of the handle bars as they will be mounted onto the steering column with the installed twist shifter on either side.

FIG. 2 shows the handle bar assembly joined together by means of the semi-circular grooved connectors.

FIG. 3 shows the completed assembly with the mounting plate used to hold the handle bar assembly onto the steering column.

FIG. 4 shows a perspective view of how the semi-circular connectors are attached to the handle bar halves, before mounting to the steering column.

### BACKGROUND OF THE INVENTION

Mountain bikes are built to meet very demanding specifications, one of which is an easy to operate shift mechanism with a very positive action. In the heavy terrain encountered by mountain bike enthusiasts, it is extremely important not to have to move your hands to locate a shifter and that a quick twist and a click will insure a change of gear. Additionally, mountain bikes are designed for the rider to hold onto the ends of a straight handle bar for maximum stability and control. The design of the mountain bike twist shifter requires a straight handle bar, from which the shifter is slid on from one end.

In contrast road bikes are designed for smooth surfaces where riders are positioned for comfort and speed on long rides. The handle bars are curved to provide the rider a low posture and minimal wind resistance. Some riders prefer to position their hands and arms near the very center of the handle bars which offer the most aerodynamic position possible.

The shifter for road bikes has traditionally been the lever type which does not have click stops, but can be mounted easily on the frame or center of the handle bars for easy reach.

As the number of bicyclists increase and more people ride for exercise and enjoyment, there exists a need for a positive and safe twist shifter for road bikes. The problem is that a traditional “Maes Bend” handlebar of the road bike, while being highly desirable to the rider because of its rams horn curved shape, does not allow for installation of the twist shifter. Until this invention, there was no way to attach a twist shifter to the Maes Bend handlebars. There is still a long felt need for convenience of a twist shifter on road type bikes and most riders prefer the Maes Bend type handlebar configuration.

### SUMMARY OF THE INVENTION

The present invention relates to a Maes bend handlebar assembly based on a traditional shaped road bicycle handlebar that has been prefabricated in two pieces. The two piece assembly allows the manufacturer to slide a twist shifter(s) onto the handle bars during fabrication and then using bolts and a grooved semi-circular connecting device attach the two pieces to the frame without the possibility of twisting or breaking alignment during use. The final assembly has all the attributes of a one piece handle bar, except that twist shifters are now attached to the center near the upright support (steering column).

### DETAILED DESCRIPTION OF THE INVENTION

For purposes of this invention bicycles or bikes are classified as either road or mountain bikes. Road bikes are defined as having narrow tires with ram-shaped (known in the industry as a “Maes Bend”) handle bars. Mountain bikes have wider, knobby tires for extra traction and a straight handle bar. Mountain bikes can sometimes have end bars which are clamped onto the end portions of the straight bar for added comfort when sitting upright.

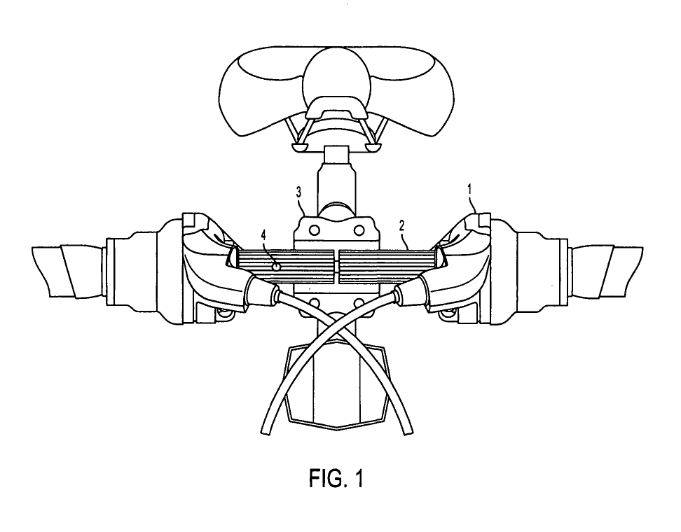

The twist shifter (FIG. 1, #1) of this invention is designed to slide over the end of a straight handle bar and is then secured by tightening a set-screw to position the shifter on the bar. To allow the shifter to be installed onto a standard “Maes Bend” shaped road bike handle bar, it is necessary to cut the curved handle bar at the center. The twist shifters can then be installed over the straight center portion (FIG. 1, #2) of the handle bars and set into position with the set-screw assembly. Typically two shifters are installed, with one on each side of the steering column, but it may be desirable to have only one shifter. If only one shifter is used in the assembly, it may be mounted on either side of the steering column. The side on which a single shifter is mounted depends on personal preference and handedness of the rider.

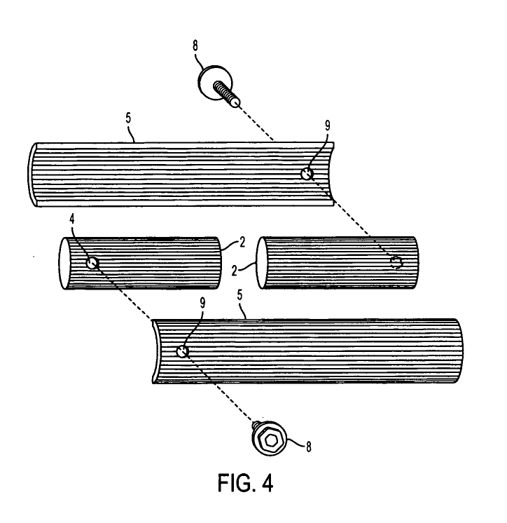

The two halves of the handle bar that result from cutting the bar in half must now be reattached after the twist shifters are in place. Each half of the handle bar is fitted with a series of horizontal grooves and a hole (FIGS. 1 and 4, #4) to receive a bolt or screw. The various ways of introducing these grooves would be obvious to one skilled in the art.

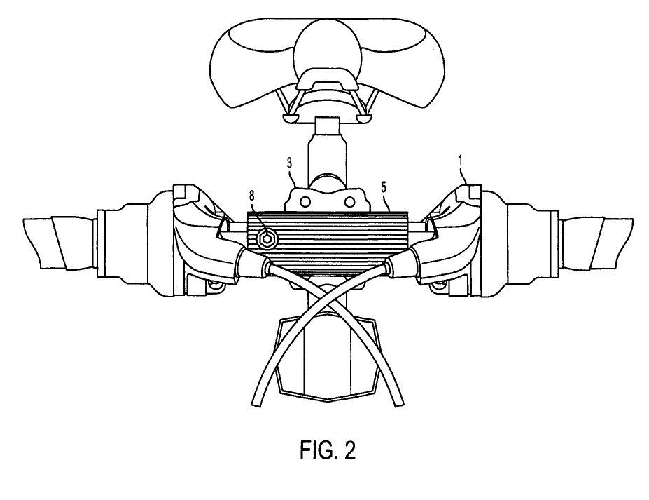

Two grooved semi-circular connectors (FIGS. 2 and 4, #5) are used to attach the two handle bar halves together and are held in place with two screws or bolts (FIG. 4, #8). The grooved semi-circular connectors contain a series of horizontal grooves on both the inside and outside of the curved surface of the connector. The inside grooves mate with the handlebar halves while the outside grooves mate with and secure the assembly to the steering column.

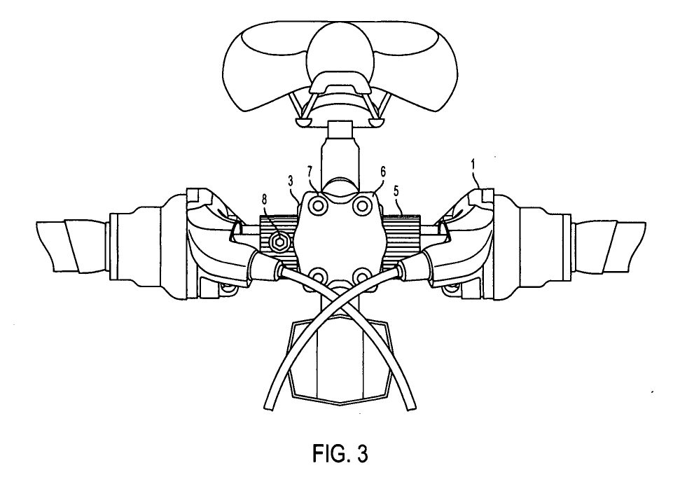

The completed assembly as shown in FIG. 2 acts as a one piece handle bar in that it will not twist or break alignment when in use. The series of grooves on the outside of the semi-circular grooved connectors mesh with the series of grooves on the steering column (FIG. 2, #3) and the mounting plate (FIG. 3, #6). The assembly is held in place by a series of bolts (FIG. 3, #7) which allows the user to adjust the handle bar assembly to the desired angle before the bolts are tightened. Once all the assembly bolts are tightened there should be no twisting or sliding of the handle bar assembly with respect to the steering column.

In an embodiment of this invention an adhesive can be used to help secure the bolts (FIG. 4, #8 and FIG. 3, #7) so as to prevent them from loosening as a result of vibration during use. Non-limiting examples of some adhesives are epoxy, cyanoacrylate, polyurethane, and other high strength adhesives. One skilled in the art would of course recognize that water borne adhesives should be avoided so as to prevent being washed away when riding the bicycle in the rain.

What is claimed:

1. A bicycle handlebar assembly comprising a Maes bend handlebar first half and a Maes bend handlebar second half, a locking mechanism located on one end of the first half and a locking mechanism located on one end of the second half for locking said first half and said second half together by means of a pair of grooved semi-circular connectors and at least one twist shift device mounted on either the first half or second half of the Maes bend handlebar assembly; said pair of grooved semi-circular connectors are held in place by means of a first bolt threaded into the first half of the handlebar and a second bold threaded into the second half of the handlebar.

2. The handlebar assembly of claim 1 wherein the locking mechanism is a plurality of grooves for mating with a plurality of matching grooves located on the pair of semi-circular connectors.

3. The handlebar assembly of claim 2 wherein the locking mechanism additionally contains a hole for engaging a pin in a steering column of a bicycle.

4. A bicycle containing the handlebar assembly of claim 2 wherein the assembly is mounted to a steering column by means of a mounting plate.

5. The bicycle of claim 4 wherein the steering column and the mounting plate contain grooves to align with grooves on the pair of semi-circular connectors.
